(19) United States
(12) Patent Application Publication
(10) Pub. No.: US 2026/0125573 A1
(43) Pub. Date: May 7, 2026

(54) POLYMER DISPERSIONS FOR PRODUCING COATING COMPOSITIONS WITH IMPROVED WET SCRUB RESISTANCE

(71) Applicant: Celanese International Corporation, Irving, TX (US)

(72) Inventors: Matthias Junk, Alsbach-Hähnlein (DE); Eunsoo Kang, Frankfurt (DE); Harald Petri, Aarbergen (DE); Maximilian Nau, Mühltal (DE)

(73) Assignee: Celanese International Corporation, Irving, TX (US)

(21) Appl. No.: 19/367,453

(22) Filed: Oct. 23, 2025

Related U.S. Application Data
(60) Provisional application No. 63/717,446, filed on Nov. 7, 2024.

(51) Int. Cl. C09D 133/06; C08F 220/18; C09D 5/02

(52) U.S. Cl. CPC C09D 133/068; C08F 220/1808; C09D 5/022; C08F 2800/10

(57) ABSTRACT

A coating composition (e.g., a paint) may include: a pigment; a filler, a polymer dispersion; and a thickener. The polymer dispersion may include a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture and (ii) one or more epoxy-functional monomers in an amount to yield 3.0-10.0 mmol epoxy-functional groups per 100 g monomer mixture.

### CROSS-REFERENCE TO RELATED APPLICATIONS

This application claims priority to U.S. Provisional Patent Application No. 63/717,446, filed Nov. 7, 2024, the disclosure of which is incorporated herein by reference.

### FIELD OF THE INVENTION

The present disclosure relates generally to polymer dispersions suitable for producing coating compositions, especially interior paints, with improved wet scrub resistance. Specifically, the polymer dispersion comprises a polymer formed by polymerization of monomers that include carboxylic acid-functional monomers, epoxy-functional monomers, and optionally silane-functional monomers where the relative amounts of each functional group is controlled in the monomer mixture used to produce the polymer dispersion.

### BACKGROUND OF THE INVENTION

Waterborne copolymer dispersions are well known as binders in the production of coating compositions such as plasters, renders, adhesives, and paints. Advantages of using waterborne systems for paints include low cost, ease of application and cleanup, reduced drying times, and low or no odor or emissions of volatile organic compounds (VOC). For interior paints, where good mechanical properties at low binder content are required, wet scrub resistance (WSR) is a critical performance criterion. To date, many different proposals have been advanced to improve the wet scrub resistance of paints. However, there remains a need for versatile waterborne copolymer dispersions that exhibit excellent wet scrub performance at a high pigment volume content.

### SUMMARY OF THE INVENTION

An example aqueous polymer dispersion for improving wet scrub resistance of a coating may comprise a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture, (ii) one or more epoxy-functional monomers in an amount to yield 3.0-10.0 mmol epoxy-functional groups per 100 g monomer mixture, and (iii) 0.5-5 mmol of an ethylenically unsaturated silane-functional monomer and/or 0.5-5 mmol of an silane-functional compound.

Another example of an aqueous polymer dispersion for improving wet scrub resistance of a coating may comprise a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture and (ii) one or more epoxy-functional monomers in an amount to yield 3.0-10.0 mmol epoxy-functional groups per 100 g monomer mixture, wherein a molar ratio of carboxylic acid to epoxy groups in the range of 1.2-3.0, preferably 1.2-2.5.

An example coating composition may comprise a) a pigment; b) a filler; c) any of the foregoing aqueous polymer dispersions. The coating composition may be an interior paint. The pigment volume concentration is 60 vol % or greater based on a total volume of the coating composition.

Another example coating composition may comprise a) a pigment; b) a filler; c) an aqueous polymer dispersion comprising a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture and (ii) one or more epoxy-functional monomers in an amount to yield 3.0-10.0 mmol epoxy-functional groups per 100 g monomer mixture. The coating composition may be an interior paint. The pigment volume concentration is 60 vol % or greater based on a total volume of the coating composition.

### DETAILED DESCRIPTION OF THE INVENTION

Described herein are polymer dispersions as well as coating compositions (e.g., paints) incorporating the polymer dispersions. The polymer dispersion comprises a polymer produced by free-radically initiated emulsion polymerization of a mixture of ethylenically unsaturated monomers. Specifically, the mixture of ethylenically unsaturated monomers includes carboxylic acid-functional monomers, epoxy-functional monomers, and optionally silane-functional monomers. Without being limited by theory, it is believed that controlling the amount of each of the carboxylic acid, epoxy, and silane functional groups in the monomer mixture used to produce the polymer dispersion produces a polymer dispersion that in a coating composition improves the wet scrub resistance while maintaining stability and mitigating coagulum formation.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references, e.g., meaning “one or more,” unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

As used herein, the term “comprises” and variations thereof is open-ended, but for purposes of the specification and as support for future claim amendments, it should be understood as alternatively disclosing more restrictive language, such as “consisting essentially of” or “consisting of.”

As used herein, the term “biorenewable (or biobased) carbon” is intended to mean carbon obtained from a biological source rather than a fossil oil based source. The biorenewable carbon of a monomer, a polymer, or a polymer composition can be determined using a method such as described in ASTM D6866-16 and ISO 16620. ASTM D6866-16 and ISO 16620-2 provide three different methods for determining the biorenewable content of a solid, liquid, or gaseous composition. For example, the compositions described herein can be dried as a film and tested as a solid. As defined by ASTM D6866-16 and ISO 16620-1, the biobased carbon content is the amount of biobased carbon in the material or product as a percent of the weight (mass) of the total organic carbon in the product. In particular, ASTM D6866-16 Method B measures the ratios of ¹⁴C/¹²C and ¹³C/¹²C in the composition using Accelerator Mass Spectrometry (AMS) and Isotope Ratio Mass Spectrometry (IRMS). Fossil based carbon contains essentially no ¹⁴C because its age is much greater than the 5,730 year half-life of ¹⁴C. Thus, the presence and level of ¹⁴C in a composition provides a direct measure of the amount of carbon that originated from a source other than a fossil fuel, i.e., the level of biobased carbon in the composition. If the biobased carbon contents of all raw materials in a mixture are known, it is also possible to calculate the biobased carbon content of the mixture according to ISO 16620-1.

### Aqueous Polymer Dispersions

The coating compositions described herein include an aqueous polymer dispersion system that contains polymer particles in disperse distribution as the disperse phase in an aqueous medium. The polymer dispersions can be prepared as monomer mixtures in an aqueous medium and then polymerized, for example through an emulsion polymerization, to produce the polymer dispersion. In some aspects, the emulsion polymerization process is a free radically initiated polymerization.

The monomer mixture of the aqueous dispersion, prior to polymerization, contains a monomer mixture of ethylenically unsaturated monomers. Specifically, the ethylenically unsaturated monomers include one or more carboxylic acid-functional monomers, one or more epoxy-functional monomers, and optionally one or more silane-functional monomers.

Balancing the amount of each of the functional groups present in the monomer mixture may provide a balance of properties (e.g., wet scrub resistance, stabilization, and coagulum formation) for coating compositions produced therewith. Without being limited by theory, it is believed that a minimum level of carboxylic acid groups is needed in the monomer mixture to produce a polymer with sufficient stability, but too many carboxylic acid groups reduce the wet scrub resistance of the coating composition. Further, a minimum level of epoxy groups is needed in the monomer mixture to produce a polymer with sufficient wet scrub resistance, but too many epoxy groups increase the propensity for coagulum formation. Because monomers may have one or more of the designated functional groups, the concentration of the monomers is based on an amount in mmol of the functional group per 100 g of the monomer mixture. As a result, a dicarboxylic acid-functional monomer may be used in lower amounts than a monocarboxylic-acid functional monomer to achieve the same amount of carboxylic acid groups per 100 g monomer mixture.

The one or more carboxylic acid-functional monomers may be present in the monomer mixture in an amount to yield 10.0-22.0 mmol carboxylic acid groups per 100 g monomer mixture (e.g., 11.0-21.0 mmol carboxylic acid groups per 100 g monomer mixture, 13.0-21.0 mmol carboxylic acid groups per 100 g monomer mixture, or 14.0-20.0 mmol carboxylic acid groups per 100 g monomer mixture).

Examples of carboxylic acid-functional monomers may include, but are not limited to, an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, the like, and any combination thereof. Preferably, one or both of methacrylic acid and acrylic acid may be included in the carboxylic acid-functional monomers.

The one or more epoxy-functional monomers may be present in the monomer mixture in an amount that yields 3.0-10.0 mmol epoxy groups per 100 g monomer mixture (e.g., 4.0-10.0 mmol epoxy groups per 100 g monomer mixture, or 5.0-9.0 mmol epoxy groups per 100 g monomer mixture, such as 6.0-8.0 mmol epoxy groups per 100 g monomer mixture).

The epoxy-functional monomers may be glycidyl compounds. Examples of epoxy-functional monomers may include, but are not limited to, glycidyl acrylate, glycidyl methacrylate, allyl glycidyl ether, vinyl glycidyl ether, the like, and any combination thereof. Preferably, one or both of glycidyl acrylate and glycidyl methacrylate may be included in the epoxy-functional monomers.

A molar ratio of the carboxylic acid groups and the epoxy groups in the monomer mixture may range from 1.2-3.5 (e.g., 1.2-3.0, or 1.2-2.5).

When included, the one or more silane-functional monomers may be present in the monomer mixture in an amount that yields 0.5-5 mmol silane-functional groups per 100 g monomer mixture (e.g., 1-5 mmol silane-functional groups per 100 g monomer mixture, or 1.5-3 mmol silane-functional groups per 100 g monomer mixture).

Examples silane-functional monomers may include, but are not limited to, γ-methacryloxypropyltris(2-methoxyethoxy)silane, trimethoxyvinylsilane, triethoxyvinylsilane, diethoxyvinylsilanol, ethoxyvinylsilanediol, triethoxyallylsilane, tripropoxyvinylsilane, triisopropoxyvinylsilane, tributoxyvinylsilane, triacetoxyvinylsilane, trimethylglycolvinylsilane, γ-methacryloxypropyltrimethylglycolsilane, γ-acryloxypropyltriethoxysilane, γ-methacryloxypropyltrimethoxysilane, the like, and any combination thereof. Preferably, one or both of trimethoxyvinylsilane and triethoxyvinylsilane may be included in the silane-functional monomers.

Alternatively or in addition to the silane-functional monomer, the monomer mixture may comprise silane-functional compounds without ethylenically unsaturated groups. Examples of such compounds have the formula (R1)n-Si—(OR2)4-n (I), wherein n is 0, 1, 2, or 3, and R1 and R2 are each independently a C1-C15 alkyl and more preferably from C1-C6 alkyl. The alkyl groups may be straight or branched but contain no unsaturation. Suitable compounds of formula (I) are selected from the group consisting of tetramethoxysilane, tetraethoxysilane, alkyltrimethoxysilane, alkyltriethoxysilane, dialkyldimethoxysilane, dialkyldiethoxysilane, trialkylmethoxysilane, and trialkylethoxysilane. Suitable silane-functional compounds include tetramethoxysilane, tetraethoxysilane, methyltrimethoxysilane, ethyltrimethoxysilane, propyltrimethoxysilane, butyltrimethoxysilane, pentyltrimethoxysilane, hexyltrimethoxysilane, methyltriethoxysilane, ethyltriethoxysilane, propyltriethoxysilane, butyltriethoxysilane, pentyltriethoxysilane, and hexyltriethoxysilane. Preferred suitable silanes carry at least one amino, epoxy, ureido, or mercapto functional group on R1. Examples of this class of saturated silanes include N-(2-aminoethyl)-3-aminopropyltrimethoxysilane, N-(2-aminoethyl)-3-aminopropylmethyldimethoxysilane, N-cyclohexyl-3-aminopropyltrimethoxysilane, N-phenyl-3-aminopropyltrimethoxysilane 3-aminopropyltrimethoxysilane, 3-aminopropyl triethoxysilane, γ-ureidopropyltrimethoxysilane γ-(3,4-epoxycyclohexyl)ethyltrimethoxysilane and γ-glycidoxypropyl trimethoxysilane, γ-glycidoxypropyltriethoxysilane, γ-mercaptopropyltrimethoxysilane, γ-mercaptopropyltriethoxysilane, γ-mercaptopropylmethyldiethoxysilane. Since they do not form part of the final copolymer, such saturated silane-functional compounds can be added before, during or after the polymerization process.

In addition to the carboxylic acid-, epoxy-, and silane-functional monomers, the monomer mixture may comprise additional stabilizing monomers such as ethylenically unsaturated sulfonic, phosphonic and phosphoric acids, such as vinyl sulfonic acid, 2-acrylamido-2-methylpropanesulfonic acid, vinylphosphonic acid, esters of phosphonic or phosphoric acid with hydroxyalkyl(meth)acrylates and ethylenically unsaturated polyethoxyalkylether phosphates, alkali metal or ammonium salts of the unsaturated sulfonic, phosphonic and phosphoric acids, and ethylenically unsaturated carboxylic amides, such as methacrylamide and acrylamide. Preferably, the combined amount by weight of these additional stabilizing monomers is smaller than the combined amount by weight of carboxylic acid-, epoxy-, and silane-functional monomers. More preferably, the combined amount by weight of these additional stabilizing monomers is smaller than the combined amount by weight of carboxylic acid- and epoxy-functional monomers. Most preferably, the combined amount by weight of these additional stabilizing monomers is smaller than the combined amount by weight of carboxylic acid-functional monomers.

In addition to the carboxylic acid-, epoxy-, and silane-functional monomers and additional stabilizing monomers, the monomer mixture may include other monomers. Examples of other monomers that may be included in the monomer mixture may include, but are not limited to, C₁-C₁₄ alkyl esters of acrylic acid, C₁-C₁₄ alkyl esters of methacrylic acid, vinyl aromatic monomers (e.g., styrene and vinyltoluene), vinyl halogenide monomers, acrylonitrile, methacrylonitrile, vinyl esters (e.g., vinyl acetate), olefins (e.g., ethylene and butadiene), the like, and any combination thereof. In some embodiments, the monomer mixture can optionally contain further functional co-monomers, including, for example, aldehyde or keto group-containing monomers, ureido co-monomers, hydroxy-functional co-monomers, polyfunctional co-monomers and combinations of these optional functional co-monomers.

Examples of C₁-C₁₄ alkyl esters of acrylic acid and C₁-C₁₄ alkyl esters of methacrylic acid may include, but are not limited to, ethyl acrylate, n-butyl acrylate, iso-butyl acrylate, tert-butyl acrylate, n-octyl acrylate, 2-octyl acrylate, 2-ethylhexyl acrylate, 2-ethylhexyl methacrylate, n-dodecyl methacrylate, n-dodecyl acrylate, tridecyl methacrylate, the like, and any combination thereof. 2-octyl acrylate is a preferred alkyl ester of acrylic acid. The C₁-C₁₄ alkyl esters of acrylic acid and C₁-C₁₄ alkyl esters of methacrylic acid may have a biorenewable carbon content of at least 50% (e.g., at least 60%, at least 70%, at least 80%, at least 90 wt %, up to 100%), by weight of the total carbon content of the ester.

When included, the C₁-C₁₄ alkyl esters of acrylic acid and/or C₁-C₁₄ alkyl esters of methacrylic acid, in total, may be present in the monomer mixture in an amount of at least 50 wt % (e.g., from 50 to 97.5 wt %, from 65 to 97 wt %, from 80 to 96 wt %, or from 90 to 96 wt %), based on the weight of the monomer mixture.

When included, the vinyl aromatic monomers may be present in the monomer mixture in an amount from 1 to 50 wt % (e.g., from 1 to 40 wt %, from 3 to 15 wt %, or from 5 to 10 wt %), based on the weight of the monomer mixture.

The relative amounts of the monomers in the monomer mixture may be selected so that the final polymer has a glass transition temperature, T_{g}, from −10° C. to +50° C. (e.g., from −5° C. to +30° C., from −5° C. to +20° C., from −5 to +15° C., or from −5 to +10° C.) as determined by differential scanning calorimetry (DSC) according to ISO 16805.

The aqueous polymer dispersion of the present disclosure may have a total volatile organic compound content, as determined by gas chromatography according to ISO 11890-2, of 2000 ppm or less.

### Stabilization System

Both during polymerization and thereafter, the present polymer may be stabilized in the form of an aqueous polymer dispersion or latex. The aqueous polymer dispersion of the present disclosure therefore may be prepared in the presence of and contain a stabilization system, which generally comprises emulsifiers, in particular nonionic emulsifiers and/or anionic emulsifiers and/or protective colloids. Mixtures of the different stabilizers may also be employed.

The amount of emulsifier employed may be at least 0.5 wt %, based on the weight of the monomer mixture. Generally, emulsifiers may be used in amounts up to about 5 wt %, based on the weight of the monomer mixture. Emulsifiers employed with preference herein may be nonionic emulsifiers having alkylene oxide groups and/or anionic emulsifiers having sulfate, sulfonate, phosphate, and/or phosphonate groups. Such emulsifiers, if desired, may be used together with molecularly or dispersely water-soluble polymers. Preferably also the emulsifiers used may contain no alkylphenolethoxylate (APEO) structural units.

Examples of suitable nonionic emulsifiers may include, but are not limited to, acyl, alkyl, oleyl, and alkylaryl ethoxylates. These products are commercially available, for example, under the name GENAPOL®, LUTENSOL® or EMULAN®. Theses may include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₀-C₁₄ fatty alcohol (3-40) ethoxylates, C₁₁-C₁₅ oxo-process alcohol (3-40) ethoxylates, C₁₆-C₁₈ fatty alcohol (11-80) ethoxylates, C₁₈ oxo-process alcohol (3-40) ethoxylates, C₁₃ oxo-process alcohol (3-40) ethoxylates, polyoxyethylenesorbitan monooleate with 20 ethylene oxide groups, polymers of ethylene oxide and propylene oxide having a minimum ethylene oxide content of 10% by weight, the polyethylene oxide (4-40) ethers of oleyl alcohol, and the polyethene oxide (4-40) ethers of nonylphenol. Particularly suitable are the polyethylene oxide (4-40) ethers of fatty alcohols, more particularly of oleyl alcohol, stearyl alcohol or C₁₈ alkyl alcohols.

The amount of nonionic emulsifiers used in preparing the aqueous polymer dispersion of the present disclosure may be up to about 5% by weight, preferably up to about 3% by weight, more preferably up to about 2% by weight, based on the total weight of the monomer mixture. Mixtures of nonionic emulsifiers may also be employed.

Examples of suitable anionic emulsifiers may include, but are not limited to, sodium, potassium, and ammonium salts of linear aliphatic carboxylic acids of chain length C₁₂-C₂₀, sodium hydroxyoctadecanesulfonate, sodium, potassium, and ammonium salts of hydroxy fatty acids of chain length C₁₂-C₂₀ and their sulfonation and/or sulfation and/or acetylation products, alkyl sulfates, including those in the form of triethanolamine salts, alkyl(C₁₀-C₂₀) sulfonates, alkyl(C₁₀-C₂₀) arylsulfonates, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium alkyl sulfate, sulfated alkyl or aryl ethoxylate with EO degree between 1 and 30, for example ethoxylated sodium lauryl ether sulfate or a salt of a bisester, preferably of a bis-C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of bis-C₄-C₁₈ alkyl esters of sulfonated succinic acid, or phosphates of polyethoxylated alkanols. Preferable anionic emulsifiers may include sodium or potassium alkyl sulfates such as sodium lauryl sulfate, and sodium, potassium or ammonium salts of sulfated C₁₀-C₁₆ alkyl ethoxylates with an EO degree between 1 and 30.

The amount of anionic emulsifiers used may typically range from about 0.1% to about 3.0% by weight (e.g., from about 0.1% to about 2.0% by weight, or from about 0.5% to about 1.5% by weight), based on the total weight of the monomer mixture. Mixtures of anionic emulsifiers may also be employed.

Also suitable as stabilizers for the present dispersions are copolymerizable nonionic and anionic surfactants such as those disclosed in US 2014/0243552. Other suitable copolymerizable surfactants are sold under the trade names HITENOL® BC, HITENOL® KH, HITENOL® AR, ADEKA REASOAP SR, and ADEKA REASOAP ER.

Along with emulsifiers, the aqueous polymer dispersion of the present disclosure may also comprise as part of the stabilizer system a selected type of protective colloid based on cellulose ethers, poly vinyl alcohol, poly vinyl pyrrolidone, polyacrylic acid, maleic acid styrene copolymers, or other water soluble polymers. Suitable protective colloids used in the aqueous polymer dispersion of the present disclosure may include water-soluble or water-dispersible polymeric modified natural substances based on cellulose ethers. Such cellulose ethers may have a viscosity, when tested as a 1 wt % aqueous in water at 25° C., of 5 to 5,000 mPas (e.g., 10 to about 1,500 mPas, or 10 to 500 mPas). Mixtures of celluloses ethers may be used to achieve these viscosity values. Examples of suitable cellulose ether materials may include, but are not limited to, methyl cellulose, hydroxyethyl cellulose, hydroxypropyl cellulose, hydroxypropyl methyl cellulose, ethyl hydroxyethyl cellulose, methyl hydroxyethyl cellulose, the like, and any combination thereof. Carboxymethyl cellulose (CMC) may be preferred, as described in U.S. Pat. No. 4,492,780.

Hydrophobically modified cellulose ethers may also be employed as the protective colloid in the polymer dispersions herein. Such materials comprise cellulose ethers which have been hydrophobically modified with long chain hydrocarbon groups to reduce their water solubility. Hydrophobically modified cellulose ethers of this type are those described, for example, in U.S. Pat. Nos. 4,228,277; 4,352,916 and 4,684,704; all of which patents are incorporated herein by reference.

The protective colloids may be used individually or in combination. In the case of combinations, the two or more colloids may each differ in their molecular weights or they may differ in their molecular weights and in their chemical composition, such as the degree of hydrolysis, for example.

When protective colloids are used, the amount thereof, based on the total weight of the monomer mixture, may be 0.1 to 5 parts by weight (e.g., 0.3 to 5 parts by weight).

In a preferred variant, the aqueous polymer dispersion of the present disclosure contain no protective colloid at all, or the amount of protective colloid, based on the total weight of the monomer mixture, is less than 1% by weight (e.g., less than 0.7% by weight).

In a particularly preferred variant, the present dispersions neither contain protective colloids nor nonionic emulsifiers.

In addition to the emulsifiers and protective colloids that are used during the emulsion polymerization of the polymers herein, it is also possible to add further emulsifiers, protective colloids and/or other stabilizers after the polymerization.

### Production of the Polymer Dispersion

The aqueous polymer dispersion of the present disclosure may be produced by free radical emulsion polymerization of the monomer mixture described above in an aqueous medium and in the presence of one or more free radical initiators. The polymerization may be conducted either in a single stage or in multiple stages. The polymer produced in each stage may have a constant or a varying T_{g}. Preferably, the polymerization is conducted such that a dispersion with one defined T_{g} is obtained. Suitable free radical initiators may include, but are not limited to, hydrogen peroxide, benzoyl peroxide, cyclohexanone peroxide, isopropyl cumyl hydroperoxide, persulfates of potassium, of sodium and of ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl) hexanoyl peroxide, tert-butyl perpivalate, hydroperoxypinane, p-methane hydroperoxide. The abovementioned compounds may also be used within redox systems, using transition metal salts, such as iron(II) salts, and/or other reducing agents. Alkali metal salts of oxymethanesulfinic acid, hydroxylamine salts, sodium dialkyldithiocarbamate, sodium bisulfite, ammonium bisulfite, sodium dithionite, diisopropyl xanthogen disulfide, ascorbic acid, tartaric acid, and isoascorbic acid may also be used as reducing agents.

The polymerization temperature generally may range from 20° C. to 150° C. (e.g., 50° C. to 120° C., or 60° C. to 95° C.). The copolymerization may be undertaken by batch, semi batch, or continuous emulsions polymerization, i.e., by processes in which all the monomer is added upfront or by monomer slow add processes. Any reactor system such as batch, loop, continuous, cascade, and the like may be employed.

On completion of the polymerization, a further, preferably chemical after-treatment, especially with redox catalysts, for example combinations of the above-mentioned oxidizing agents and reducing agents, may follow to reduce the level of residual unreacted monomer on the product. In addition, residual monomer can be removed in known manner, for example by physical demonomerization, i.e., distillative removal, especially by means of steam distillation, or by stripping with an inert gas. A particularly efficient combination may use both physical and chemical methods, which permits lowering of the residual monomers to very low contents (<1000 ppm, preferably <100 ppm).

The polymerized particles produced by the present process typically have a weight-averaged diameter of less than 200 nm (e.g., less than 150 nm, or less than 120 nm), as measured by a combination of laser diffraction and polarization intensity differential scattering (PIDS) using a Beckman Coulter LS 13320 Particle Size Analyzer.

In addition to the monomers described herein, the final polymers may also contain a water-soluble or water-dispersible cross-linking agent. Such a cross-linking agent will react with specific polymer functionalities such as carbonyl or 1,3-dicarbonyl groups as water is removed from the coating compositions herein and as a film or coating is formed from the polymerized components.

A type of water-soluble cross-linking agent that may be used in the compositions herein comprises a compound which contains at least two hydrazine and/or hydrazide moieties. Particularly suitable may include, but are not limited to, dihydrazine compounds of aliphatic dicarboxylic acids of 2 to 10, in particular 4 to 6, carbon atoms, e.g., oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Water-soluble aliphatic dihydrazines of 2 to 4 carbon atoms, e.g., ethylene-1,2-dihydrazine, propylene-1,3-dihydrazine or butylene-1,4-dihydrazine, are also suitable. Adipic acid dihydrazide (ADH) may be a preferred water-soluble cross-linking agent for use in the compositions herein, especially those produced from monomer compositions containing diacetone acrylamide (DAAM).

Other suitable water-soluble cross-linking agents may be compounds that contain at least two amine functional moieties such as ethylene diamine and hexamethylene diamine. Such cross-linking agents may preferably be used in combination with polymers comprising 1,3-dicarbonyl groups, such as acetoacetoxyethyl methacrylate (AAEM).

Yet other suitable water-soluble or water-dispersible crosslinking agents may be compounds comprising at least two oxazoline groups, as described in, e.g., WO 2015197662 A1, compounds comprising at least two groups with free or blocked isocyanate functionality, as described in, e.g., WO 2016118502 A1, compounds comprising at least two carbodiimide functional units, as described in, e.g., US2015099843 A1, and compounds comprising at least two aminoxy-functional groups, as described in, e.g., WO 2015150508 A1.

Generally, such water-soluble cross-linking agents may be post added to the dispersion such that the molar ratio of cross-linking agent functional groups to polymer functional groups is between about 0.1 and about 2.0. More preferably, the molar ratio of cross-linking agent functional groups to polymer functional groups in the blend may be between about 0.5 and 2.0.

After polymerization, the dispersion may preferably be neutralized to alkaline pH. This may be accomplished by, for example, the addition of an organic or inorganic base, such as an amine, ammonia or an alkali metal hydroxide, such as potassium hydroxide. In some embodiments, it is preferred to effect neutralization with a nitrogen-free base.

In addition, before use, the polymer dispersion may be dried to form a water redispersible powder, for example, to assist storage or transportation.

The final aqueous polymer dispersion described herein may have a biorenewable carbon content of at least 20% (e.g., at least 30%, at least 40%, at least 45%) by weight of the total carbon content of the polymer dispersion according to ISO 16620-1.

### Coating Compositions

The aqueous polymer dispersion described herein may be particularly useful as a binder for waterborne coating. Preferred coating compositions include emulsion paints, emulsion finishes, and glazes. Paint formulations may include low emission interior or exterior paints, preferably low emission interior paints. In the context of using the aqueous polymer dispersion described herein in coating compositions, a particular feature of the aqueous polymer dispersions is the ability to confer a very good wet scrub resistance over a broad range of pigment volume concentrations (PVC). Preferably, the coating composition may be an interior paint.

Where appropriate, the coating compositions described herein may also optionally comprise a wide variety of conventional additives, such as fillers, pigments, and auxiliaries including defoamers, surfactants, dispersants, biocides, rheology modifiers, freeze-thaw additives, formaldehyde scavenger like urea, complexing agents like EDTA or thickeners, which are typically used in the formulation of binders and/or adhesives. Such optional additives may be present in the polymer dispersion from the beginning of or during polymerization, may be added to the dispersion post-polymerization or, such as in the case of fillers, may be used in connection with preparation of the aqueous coating compositions from the polymer dispersions as hereinafter described.

The solids content of the coating compositions described herein may range from about 30 wt % to about 75 wt % (e.g., 40 wt % to about 65 wt %), based on a total weight of the coating composition. The solids are to be understood as meaning all constituents of the preparation except for water, but at least the total amount of solid binder, filler, pigment, plasticizer, and polymeric auxiliaries.

Conventional optional additives for the polymer dispersions herein may include, for example, film-forming assistants, such as white spirit, TEXANOL®, TXIB®, butyl glycol, butyl diglycol, butyl dipropylene glycol, and butyl tripropylene glycol; wetting agents, such as AMP 90®, TEGOWET 280®, FLUOWET PE®; defoamers, such as mineral oil defoamers or silicone defoamers; UV protectants, such as TINUVIN® 1130; agents for adjusting the pH; preservatives; plasticizers, such as dimethyl phthalate, diisobutyl phthalate, diisobutyl adipate, COASOL B®, PLASTILIT 3060®, and TRIAZETIN®; subsequently added stabilizing polymers, such as polyvinyl alcohol or additional cellulose ethers; and other additives and auxiliaries of the kind typical for the formulation of binders. The amounts of these additives used in the aqueous polymer dispersions herein can vary within wide ranges and can be selected by the specialist in view to the desired area of application. Preferred coating compositions contain less than 0.5%, such as less than 0.1%, of coalescent agents, plasticizers, or organic solvents.

The PVC of the pigment-containing coating compositions (e.g., paints) may be 60 vol % to 90 vol % (e.g., 65 vol % to 90 vol %, or 70 vol % to 90 vol %), based on a total volume of the coating composition. PVC represents the volume of pigments plus fillers in the coating composition divided by the volume of pigments, fillers, and binders (including the polymer of the polymer dispersion described herein) times 100%. PVC is described in greater detail in U.S. Patent Publication No. 2010/0056696, which is incorporated herein by reference.

Pigments that may be used are all pigments known to the person skilled in the art for said intended use. Pigments used in the coating compositions of the present disclosure, preferably for emulsion paints, especially interior paints, may include, but are not limited to, titanium dioxide, preferably in the form of rutile, barium sulfate, zinc oxide, zinc sulfide, basic lead carbonate, antimony trioxide, lithopone (zinc sulfide and barium sulfate), iron oxides, carbon black, graphite, luminescent pigments, zinc yellow, zinc green, ultramarine, manganese black, antimony black, manganese violet, Paris blue, Schweinfurt green, sepia, gamboge, Cassel brown, toluidine red, para red, Hansa yellow, indigo, azo dyes, anthraquinoid and indigoid dyes and dioxazine, and quinacridone, phthalocyanine, isoindolinone, metal complex pigments, the like, and any combination thereof.

In order to increase the hiding power and to save white pigments, finely divided fillers, such as, for example, precipitated calcium carbonate or mixtures of different calcium carbonates having different particle sizes, are preferably frequently used in emulsion paints. Mixtures of colored pigments and fillers are preferably used for adjusting the hiding power of the hue and the depth of color. In some embodiments, hollow polymer particles may be used to increase the dry hiding power of the coatings.

Fillers that may be used are all fillers known to the person skilled in the art for said intended use. Examples of fillers may include, but are not limited to, aluminosilicates (e.g., feldspars), silicates (e.g., kaolin, talc, mica), magnesite, alkaline earth metal carbonates (e.g., calcium carbonate, for example in the form of calcite or chalk, magnesium carbonate, dolomite), alkaline earth metal sulfates (e.g., calcium sulfate), silica, the like, and any combination thereof. The fillers may be used either as individual components or as filler mixtures, for example, calcium carbonate/kaolin and calcium carbonate/talc.

The filler may be present in the coating composition at a concentration ranging from 30 wt % to 90 wt % (e.g., 30 wt % to 70 wt %, or 50 wt % to 90 wt %), based on a total weight of the solids in the coating composition.

The customary auxiliaries may include wetting agents or dispersants, such as sodium, potassium, or ammonium polyphosphates, alkali metal and ammonium salts of polyacrylic acids and of polymaleic acid, polyphosphonates, such as sodium 1-hydroxyethane-1,1-diphosphonate, and naphthalenesulfonic acid salts, in particular sodium salts thereof. In addition, suitable amino alcohols, such as, for example, 2-amino-2-methylpropanol, may be used as dispersants. The dispersants or wetting agents may be used in an amount of from 0.1 to 2% by weight, based on the total weight of the coating composition.

Furthermore, the auxiliaries may also comprise thickeners, for example, cellulose derivatives, such as methylcellulose, hydroxyethylcellulose and carboxymethylcellulose, and furthermore casein, gum Arabic, tragacanth gum, starch, sodium alginate, polyvinyl alcohol, polyvinylpyrrolidone, sodium polyacrylates, water-soluble copolymers based on acrylic and (meth)acrylic acid, such as acrylic acid/acrylamide and (meth)acrylic acid/acrylic ester copolymers and so-called associative thickeners, such as styrene/maleic anhydride polymers or preferably hydrophobically modified polyetherurethanes (HEUR) known to the person skilled in the art, hydrophobically modified acrylic acid copolymers (HASE) or polyetherpolyols. Inorganic thickeners, such as, for example, bentonites or hectorite, may also be used. The thickeners may be used in amounts of from 0.1 to 3% by weight (e.g., 0.1 to 1% by weight), based on the total weight of the coating composition.

In addition, waxes based on paraffins and polyethylene, dulling agents, antifoams, preservatives and water repellents, biocides, fibers, and further additives known to the person skilled in the art may also be used as auxiliaries in the aqueous preparations according to the invention.

The minimum temperature required for the polymers in the coating composition to form a coating or film is referred to as the minimum film-forming temperature or MFT. MFT is related to the glass transition temperature, Tg, of the polymer of the polymer dispersion, but can also be affected by other components of such coating compositions such as coalescents. The coating compositions herein may preferably have a MFT of equal to or less than about 5° C. The coating compositions herein may preferably have a MFT of about 5° C. or less (e.g., 3° C. or less, or 1° C. or less) and be free of organic solvent, plasticizer, coalescent agent, or any combination thereof.

The aqueous polymer dispersions described herein are stable fluid systems that can be used for coating a multiplicity of substrates. Consequently, the present disclosure includes methods for coating substrates and to the coating materials themselves. Suitable substrates may include, but are not limited to, wood, concrete, mineral substrates, metal, glass, ceramics, plastic, renders, wallpapers, paper and coated, primed or weathered substrates, the like, and any combination thereof. The application of the coating composition to the substrate to be coated may be affected in a manner dependent on the form of the preparation. Depending on the viscosity and the pigment content of the preparation and on the substrate, the application can be affected by roll-coating, brushing, knife-coating, as a spray, and the like.

The following numbered embodiments are contemplated. All combinations of features and embodiments are contemplated.

Embodiment 1. An aqueous polymer dispersion for improving wet scrub resistance of a coating, comprising a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture, (ii) one or more epoxy-functional monomers in an amount to yield 3.0-10.0 mmol epoxy-functional groups per 100 g monomer mixture, and (iii) 0.5-5 mmol of an ethylenically unsaturated silane-functional monomer and/or 0.5-5 mmol of an silane-functional compound.

Embodiment 2. The aqueous polymer dispersion according to Embodiment 1, wherein a molar ratio of carboxylic acid to epoxy groups in the range of 1.2-3.5, preferably 1.2-3.0, more preferably 1.2-2.5.

Embodiment 3. An aqueous polymer dispersion for improving wet scrub resistance of a coating, comprising a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture and (ii) one or more epoxy-functional monomers in an amount to yield 3.0-10.0 mmol epoxy-functional groups per 100 g monomer mixture, wherein a molar ratio of carboxylic acid to epoxy groups in the range of 1.2-3.0, preferably 1.2-2.5.

Embodiment 4. The aqueous polymer dispersion according to any preceding Embodiment, wherein the amount of the one or more carboxylic acid-functional monomers yields 11.0-21.0 mmol carboxylic acid groups per 100 g monomer mixture, preferably 13.0-21.0 mmol carboxylic acid groups per 100 g monomer mixture, more preferably 14.0-20.0 mmol carboxylic acid groups per 100 g monomer mixture.

Embodiment 5. The aqueous polymer dispersion according to any preceding Embodiment, wherein the amount of the one or more epoxy-functional monomers yields 4.0-10.0 mmol epoxy-functional groups per 100 g monomer mixture, preferably 5.0-9.0 mmol epoxy-functional groups per 100 g monomer mixture, more preferably 6.0-8.0 mmol epoxy-functional groups per 100 g monomer mixture.

Embodiment 6. The aqueous polymer dispersion according to any preceding Embodiment, wherein the one or more carboxylic acid-functional monomers comprises a monocarboxylic acid-functional monomer, preferably methacrylic acid and/or acrylic acid.

Embodiment 7. The aqueous polymer dispersion according to any preceding Embodiment, wherein the monomer mixture contains stabilizing monomer other than the carboxylic acid-functional monomers, and wherein the amount of the one or more carboxylic acid-functional monomers exceeds an amount of all other stabilizing monomers by weight.

Embodiment 8. The aqueous polymer dispersion according to any preceding Embodiment, wherein the monomer mixture further comprises at least 50% by weight of C₁-C₁₄ alkyl esters of acrylic and methacrylic acid based on the total weight of the monomer mixture.

Embodiment 9. The aqueous polymer dispersion according to any of Embodiments 1-7, wherein the monomer mixture further comprises a C₁-C₁₄ alkyl ester of acrylic and/or a C₁-C₁₄ alkyl ester of methacrylic acid having a biorenewable carbon content of at least 50%, preferably 2-octyl acrylate.

Embodiment 10. The aqueous polymer dispersion according to any preceding Embodiment, wherein the polymer has a glass transition temperature from −10° C. to +50° C., preferably from −10° C. to +30° C., more preferably from −5 to +20° C., as determined by differential scanning calorimetry (DSC) according to ISO 16805.

Embodiment 11. The aqueous polymer dispersion according to any preceding Embodiment, wherein the aqueous polymer dispersion has a total volatile organic compound content, as determined by gas chromatography according to ISO 11890-2, of 2000 ppm or less.

Embodiment 12. A coating composition comprising: a) a pigment; b) a filler; c) the aqueous polymer dispersion according to any preceding claim.

Embodiment 13. The coating composition according to Embodiment 12, wherein the coating composition is an interior paint.

Embodiment 14. The coating composition according to Embodiment 12 or 13, wherein the pigment volume concentration is 60 vol % or greater based on a total volume of the coating composition.

Embodiment 15. The coating composition according to any one of Embodiments 12-14, wherein the coating composition has a minimum film-forming temperature of 5° C. or less, preferably 3° C. or less, more preferably 1° C. or less.

Embodiment 16. A coating composition comprising: a) a pigment; b) a filler; c) an aqueous polymer dispersion comprising a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture and (ii) one or more epoxy-functional monomers in an amount to yield 3.0-10.0 mmol epoxy-functional groups per 100 g monomer mixture.

Embodiment 17. The coating composition according to Embodiment 16, wherein the coating composition is an interior paint.

Embodiment 18. The coating composition according to Embodiment 16 or 17, wherein the pigment volume concentration is 60 vol % or greater based on a total volume of the coating composition.

Embodiment 19. The coating composition according to any one of Embodiments 16-18, wherein a molar ratio of carboxylic acid to epoxy groups in the range of 1.2-3.5, preferably 1.2-3.0, more preferably 1.2-2.5.

Embodiment 20. The coating composition according to any one of Embodiments 16-19, wherein the amount of the one or more carboxylic acid-functional monomers yields 11.0-21.0 mmol carboxylic acid groups per 100 g monomer mixture, preferably 13.0-21.0 mmol carboxylic acid groups per 100 g monomer mixture, more preferably 14.0-20.0 mmol carboxylic acid groups per 100 g monomer mixture.

Embodiment 21. The coating composition according to any one of Embodiments 16-20, wherein the amount of the one or more epoxy-functional monomers yields 4.0-10.0 mmol epoxy-functional groups per 100 g monomer mixture, preferably 5.0-9.0 mmol epoxy-functional groups per 100 g monomer mixture, more preferably 6.0-8.0 mmol epoxy-functional groups per 100 g monomer mixture.

Embodiment 22. The coating composition according to any one of Embodiments 16-21, wherein the one or more carboxylic acid-functional monomers comprises a monocarboxylic acid-functional monomer, preferably methacrylic acid and/or acrylic acid.

Embodiment 23. The coating composition according to any one of Embodiments 16-22, wherein the monomer mixture contains stabilizing monomer other than the carboxylic acid-functional monomers, and wherein the amount of the one or more carboxylic acid-functional monomers exceeds an amount of all other stabilizing monomers by weight.

Embodiment 24. The coating composition according to any one of Embodiments 16-23, wherein the monomer mixture further comprises at least 50% by weight of C₁-C₁₄ alkyl esters of acrylic and methacrylic acid based on the total weight of the monomer mixture.

Embodiment 25. The coating composition according to any one of Embodiments 16-23, wherein the monomer mixture further comprises a C₁-C₁₄ alkyl ester of acrylic and/or a C₁-C₁₄ alkyl ester of methacrylic acid having a biorenewable carbon content of at least 50%, preferably 2-octyl acrylate.

Embodiment 26. The coating composition according to any one of Embodiments 16-25, wherein the polymer has a glass transition temperature from −10° C. to +50° C., preferably from −10° C. to +30° C., more preferably from-5 to +20° C., as determined by differential scanning calorimetry (DSC) according to ISO 16805.

Embodiment 27. The coating composition according to any one of Embodiments 16-26, wherein the aqueous polymer dispersion has a total volatile organic compound content, as determined by gas chromatography according to ISO 11890-2, of 2000 ppm or less.

### EXAMPLES

Example 1-3 (Comparative). A 3 liter reactor equipped with a reflux condenser and an anchor stirrer was filled with 660 g of deionized (DI) water and 21.4 g of a 28% active aqueous solution of a sodium undecyl ether sulfate with approx. 7 ethylene oxide units. The reactor content was heated to 80° C. and 2.4% of the monomer feed, as described in Table 1, was added. A solution of 0.6 g ammonium persulfate in 12 g of water was added and the reactor contents were held at 80° C. for 15 min. Subsequently, the remaining amount of monomer feed was added to the reactor with constant dosage rate over 180 min. The reactor temperature during the feed addition was maintained at 80° C. After completion of the feed addition, the reactor content was held at 85° C. for 60 minutes and then cooled to room temperature. A 5 wt % active solution of sodium hydroxide was then added to the dispersion to achieve a pH of approx. 8.5.

The properties of the resulting polymer dispersions are summarized in Table 2.

Examples 4-6 (Inventive). The process of Examples 1-3 was repeated with varying monomer feed composition, as described in Table 1. The properties of the resulting polymer dispersion are summarized in Table 2.

Example 7 (Comparative). The process of Examples 1-3 was repeated with varying monomer feed composition, as described in Table 1.

The properties of the resulting polymer dispersion are summarized in Table 2.

TABLE 1
Composition of the monomer feeds (in grams)

| | Ex. 1 | Ex. 2 | Ex. 3 | Ex. 4 | Ex. 5 | Ex. 6 | Ex. 7 |
|---|---|---|---|---|---|---|---|
| DI water | 535 | 535 | 535 | 535 | 535 | 535 | 535 |
| Sodium alkyl ether sulfate, 28% in | 43 | 43 | 43 | 43 | 43 | 43 | 43 |
| water | | | | | | | |
| Sodium persulfate | 3 | 3 | 3 | 3 | 3 | 3 | 3 |
| Methacrylic acid (MAA) | 24 | 24 | 0 | 12 | 18 | 22 | 18 |
| Acrylic acid (AA) | 12 | 12 | 0 | 0 | 0 | 0 | 0 |
| Itaconic acid (IA) | 0 | 0 | 18 | 0 | 0 | 0 | 0 |
| Methyl methacrylate (MMA) | 564 | 564 | 564 | 480 | 480 | 480 | 480 |
| 2-Ethylhexyl acrylate (EHA) | 636 | 636 | 636 | 0 | 0 | 0 | 0 |
| 2-Octyl acrylate (2-OA) | 0 | 0 | 0 | 720 | 720 | 720 | 720 |
| Triethoxyvinylsilane | 0 | 5 | 5 | 5 | 5 | 5 | 10 |
| Glycidyl methacrylate (GMA) | 0 | 12 | 12 | 12 | 12 | 12 | 24 |

TABLE 2
Properties of the polymer dispersions

| | Solid | Brookfield | | | | | |
|---|---|---|---|---|---|---|---|
| | content | viscosity | | Coagulum | d_{w} | T_{g} | T-VOC |
| | (%)¹ | (mPa s)² | pH | (%)³ | (nm)⁴ | (° C.)⁵ | (ppm)⁶ |
| Ex. 1 | 46.3 | 775 | 8.3 | 0.010 | 113 | 7.7 | 743 |
| Ex. 2 | 46.7 | 565 | 8.3 | 0.011 | 115 | 9.7 | 1826 |
| Ex. 3 | 45.7 | 50 | 8.4 | 0.014 | 119 | 7.0 | 8260 |
| Ex. 4 | 48.2 | 780 | 8.4 | 0.029 | 114 | 8.6 | 1785 |
| Ex. 5 | 47.6 | 880 | 8.4 | 0.015 | 114 | 8.7 | 1887 |
| Ex. 6 | 47.3 | 840 | 8.3 | 0.012 | 113 | 9.0 | 1772 |
| Ex. 7 | 47.8 | 960 | 8.4 | 0.063 | 113 | 9.9 | 2938 |

¹gravimetric determination after 24 h drying at 110° C.
²measurement conditions: 20° C., 20 rpm, spindle 2
³as determined by filtration over a filter with 180 μm mesh size
⁴weight-average particle diameter as determined by a Beckman Coulter LS 13320 Particle Size Analyzer
⁵Glass transition temperature as measured by differential scanning calorimetry (DSC) according to ISO 16805
⁶Total Volatile Organic Compound (TVOC) content as determined by gas chromatography according to ISO 11890-2

⁴ weight-average particle diameter as determined by a Beckman Coulter LS 13320 Particle Size Analyzer
⁵ Glass transition temperature as measured by differential scanning calorimetry (DSC) according to ISO 16805
⁶ Total Volatile Organic Compound (TVOC) content as determined by gas chromatography according to ISO 11890-2

Example 8 (Comparative). A vinyl acetate-ethylene copolymer dispersion was prepared by reproducing Example 11 of DE 10022992 A1 with the following changes: a) no allyl acetoacetate was utilized; b) 28.8 g triethoxyvinylsilane were utilized instead of 31.82 g trimethoxyvinylsilane; c) 69.2 g GMA were added instead of 74.85 g, d) GMA was added together with vinyl acetate; the other components of the “GMA dosage” were added to the aqueous pre-charge. The utilized monomers and their amounts account for 6.9 mmol epoxy-functional groups in the monomer mixture per 100 g polymer produced and 2.9 mmol silane-functional groups in the monomer mixture per 100 g polymer produced. No carboxylic acid-functional monomers were added. This example was chosen as comparative example since the reproduction of Example 2 without any carboxylic acid-functional monomers coagulated during cooling (Example 9).

Examples 10-17 (Inventive and comparative matt interior paints). Coalescent-free matt interior paints were prepared by mixing the ingredients in Table 3 at room temperature under stirring. After dissolving and dispersing item nos. 2-5 in water, pigment and fillers as per item nos. 6-10 were dispersed consecutively by increasing the dissolver speed to 5000 rpm. After the preparation of the mill base, item nos. 11-12 were added while gently stirring. All polymer dispersions were diluted to a solid content of 45.0% before addition. The resulting paints had a solid content of approx. 64% and a pigment volume concentration (PVC) of approx. 86%.

TABLE 3
Composition of matt interior paints

| | | | | Parts per |
|---|---|---|---|---|
| Item | | Supplier | Description | weight |
| 1 | Water | | | 306 |
| 2 | TYLOSE ® | SE Tylose | Cellulosic | 4 |
| | MH 30000 YG8 | | thickener | |
| 3 | CALGON ® | ICL | Dispersing | 5 |
| | N, 10% | | agent | |
| 4 | LOPON ® 895 | ICL | Dispersing | 3.5 |
| | | | agent | |
| 5 | AGITAN ® 282 | Münzing | DEFOAMER | 2 |
| 6 | KRONOS ® 2044 | Kronos | Titanium | 60 |
| | | | dioxide | |
| 7 | SOCAL ® P2 | Imerys | Calcium | 30 |
| | | | carbonate | |
| 8 | OMYACARB ® 2 GU | Omya | Calcium | 155 |
| | | | carbonate | |
| 9 | OMYACARB ® 5 GU | Omya | Calcium | 155 |
| | | | carbonate | |
| 10 | OMYACARB ® 10 GU | Omya | Calcium | 195 |
| | | | carbonate | |
| 11 | Caustic | | | 2 |
| | soda, 20% | | | |
| 12 | Dispersion | | | 82.5 |
| | per Ex. 1-8 | | | |

Examples 18-25 (Inventive and comparative satin interior paints). Coalescent-free satin interior paints were prepared by mixing the ingredients in Table 4 at room temperature under stirring. After dissolving and dispersing item nos. 2-5 in water, pigment and fillers as per item nos. 6-7 were dispersed consecutively by increasing the dissolver speed to 5000 rpm. After the preparation of the mill base, item nos. 8-11 were added while gently stirring. All polymer dispersions were diluted to a solid content of 45.0% before addition. The resulting paints had a solid content of approx. 57% and a pigment volume concentration (PVC) of approx. 31%.

TABLE 4
Composition of satin interior paints

| | | | | Parts per |
|---|---|---|---|---|
| Item. | | Supplier | Description | weight |
| 1 | Water | | | 145 |
| 2 | TYLOSE ® | SE Tylose | Cellulosic | 3.5 |
| | H 6000 YP2 | | thickener | |
| 3 | CALGON ® | ICL | Dispersing | 5 |
| | N, 10% | | agent | |
| 4 | COADIS ™ | Coatex | Dispersing | 3 |
| | BR 3 | | agent | |
| 5 | AGITAN ® 381 | Münzing | Defoamer | 3 |
| 6 | KRONOS ® 2190 | Kronos | Titanium | 190 |
| | | | dioxide | |
| 7 | OMYA ® | Omya | Calcium | 130 |
| | extra-GU | | carbonate | |
| 8 | Caustic | | | 2 |
| | soda, 10% | | | |
| 9 | COAPUR ™ 830 W | Coatex | Rheology | 4.5 |
| | | | modifier | |
| 10 | AGITAN ® 381 | Münzing | Defoamer | 3 |
| 11 | Dispersion | | | 511 |
| | per Ex. 1-8 | | | |

The wet scrub resistance (WSR) of the above paints was tested by means of the nonwoven pad method according to ISO 11998.

The paints were applied onto Leneta foil P121-10N with a 300 μm scraper. After drying for 28 days at 23° C. and 50% relative humidity, the paint films were inserted into abrasion tester model 494 (Erichsen) with adapters for wet scrub tests according to ISO 11998 and scrubbed with ABRAFLEX®-SCHLEIFVLIES S1200 (Jost) after treatment of pad and film with a 0.25% aqueous solution of sodium n-dodecylbenzenesulfonate. Reported is the thickness loss of the paint film in μm after 200 cycles (the lower, the better).

The wet scrub resistances of the matt paints are listed in Table 5, the wet scrub resistances of the satin paints are listed in Table 6.

TABLE 5
Wet scrub resistance of matt interior paints

| | | | Silane- | |
|---|---|---|---|---|
| | Carboxylic | Epoxy | functional | |
| | acid units | units | units | |
| | (mmol/100 g | (mmol/100 g | (mmol/100 g | WSR ISO |
| | monomer | monomer | monomer | 11998 |
| Ex. | mixture) | mixture) | mixture) | (μm) |
| 10 (comp.) | 36.0 | 0 | 0 | 97 |
| 11 (comp.) | 35.5 | 6.7 | 2.8 | 66 |
| 12 (comp.) | 22.3 | 6.8 | 2.8 | 43 |
| 13 (inv.) | 11.3 | 6.9 | 2.9 | 34 |
| 14 (inv.) | 16.9 | 6.8 | 2.8 | 37 |
| 15 (inv.) | 20.6 | 6.8 | 2.8 | 39 |
| 16 (comp.) | 16.7 | 13.5 | 5.6 | 40 |
| 17 (comp.) | 0 | 6.9 | 2.9 | 42 |

TABLE 6
Wet scrub resistance of satin paints

| | | | Silane- | |
|---|---|---|---|---|
| | Carboxylic | Epoxy | functional | |
| | acid units | units | units | |
| | (mmol/100 g | (mmol/100 g | (mmol/100 g | WSR ISO |
| | monomer | monomer | monomer | 11998 |
| Ex. | mixture) | mixture) | mixture) | (μm) |
| 18 (comp.) | 36.0 | 0 | 0 | 5 |
| 19 (comp.) | 35.5 | 6.7 | 2.8 | 5 |
| 20 (comp.) | 22.3 | 6.8 | 2.8 | 3 |
| 21 (inv.) | 11.3 | 6.9 | 2.9 | 2 |
| 22 (inv.) | 16.9 | 6.8 | 2.8 | 2 |
| 23 (inv.) | 20.6 | 6.8 | 2.8 | 2 |
| 24 (comp.) | 16.9 | 13.6 | 5.7 | 2 |
| 25 (comp.) | 0 | 6.9 | 2.9 | 4 |

Paints 11 and 18 with binders prepared with a high amount of carboxylic acid-functional monomers and lacking epoxy- and silane-functional monomers exhibit the worst wet scrub resistance. Addition of epoxy- and silane-functional monomers to these carboxylic acid-rich binders only leads to a slight improvement of the wet scrub resistance, as shown by paints 12 and 19. The best wet scrub resistances are obtained for inventive paints 13-15 (WSR values below 40 μm) and 21-23 (WSR values below 3 μm), comprising binders with a significantly lower amount of carboxylic acid-functional monomers than paints 12 and 19. Paints 12 and 20 with a carboxylic acid content only slightly above the inventive range give rise to acceptable, yet notably worse wet scrub performances compared to the inventive paints 13-15 and 21-23. Furthermore, the retarding effect of itaconic acid leads to significantly higher VOC levels of the polymer dispersion, which is an unwanted feature for low emission paints. As can be inferred from paints 17 and 25, the omission of carboxylic acid units in the polymer dispersion leads to notably worse wet scrub resistances compared to the inventive paints 13-15 and 21-23. Surprisingly, a further increase of the costly epoxy- and silane-functional monomers does not improve but rather deteriorate the wet scrub resistances (comparison of paints 16 and 24 with the otherwise identical paints 14 and 22). Too high levels of these crosslinking monomers additionally leads to undesired high coagulum contents and VOC levels.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. An aqueous polymer dispersion for improving wet scrub resistance of a coating, comprising a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture, (ii) one or more epoxy-functional monomers in an amount to yield 3.0-10.0 mmol epoxy-functional groups per 100 g monomer mixture, and (iii) 0.5-5 mmol of an ethylenically unsaturated silane-functional monomer and/or 0.5-5 mmol of an silane-functional compound.

2. The aqueous polymer dispersion according to claim 1, wherein a molar ratio of carboxylic acid to epoxy groups in the range of 1.2-3.5.

3. The aqueous polymer dispersion according to claim 1, wherein the amount of the one or more carboxylic acid-functional monomers yields 11.0-21.0 mmol carboxylic acid groups per 100 g monomer mixture.

4. The aqueous polymer dispersion according to claim 1, wherein the amount of the one or more epoxy-functional monomers yields 4.0-10.0 mmol epoxy-functional groups per 100 g monomer mixture.

5. The aqueous polymer dispersion according to claim 1, wherein the one or more carboxylic acid-functional monomers comprises a monocarboxylic acid-functional monomer.

6. The aqueous polymer dispersion according to claim 1, wherein the monomer mixture contains stabilizing monomer other than the carboxylic acid-functional monomers, and wherein the amount of the one or more carboxylic acid-functional monomers exceeds an amount of all other stabilizing monomers by weight.

7. The aqueous polymer dispersion according to claim 1, wherein the monomer mixture further comprises at least 50% by weight of C₁-C₁₄ alkyl esters of acrylic and methacrylic acid based on the total weight of the monomer mixture.

8. The aqueous polymer dispersion according to claim 1, wherein the monomer mixture further comprises a C₁-C₁₄ alkyl ester of acrylic and/or a C₁-C₁₄ alkyl ester of methacrylic acid having a biorenewable carbon content of at least 50%.

9. The aqueous polymer dispersion according to claim 1, wherein the polymer has a glass transition temperature from −10° C. to +50° C., as determined by differential scanning calorimetry (DSC) according to ISO 16805.

10. The aqueous polymer dispersion according to claim 1, wherein the aqueous polymer dispersion has a total volatile organic compound content, as determined by gas chromatography according to ISO 11890-2, of 2000 ppm or less.

11. A coating composition comprising:
a) a pigment;
b) a filler;
c) the aqueous polymer dispersion according to claim 1.

12. The coating composition according to claim 11, wherein the coating composition is an interior paint.

13. The coating composition according to claim 11, wherein the pigment volume concentration is 60 vol % or greater based on a total volume of the coating composition.

14. The coating composition according to claim 11, wherein the coating composition has a minimum film-forming temperature of 5° C. or less.

15. An aqueous polymer dispersion for improving wet scrub resistance of a coating, comprising a polymer formed by radically initiated emulsion polymerization of a monomer mixture comprising ethylenically unsaturated monomers that comprise (i) one or more carboxylic acid-functional monomers in an amount to yield 10.0-22.0 mmol carboxylic acid groups per 100 g monomer mixture and (ii) one or more epoxy-functional monomers in an amount to yield 3.0-10.0 mmol epoxy-functional groups per 100 g monomer mixture, wherein a molar ratio of carboxylic acid to epoxy groups in the range of 1.2-3.0.

16. The aqueous polymer dispersion according to claim 15, wherein the amount of the one or more carboxylic acid-functional monomers yields 11.0-21.0 mmol carboxylic acid groups per 100 g monomer mixture.

17. The aqueous polymer dispersion according to claim 15, wherein the amount of the one or more epoxy-functional monomers yields 4.0-10.0 mmol epoxy-functional groups per 100 g monomer mixture.

18. The aqueous polymer dispersion according to claim 15, wherein the one or more carboxylic acid-functional monomers comprises a monocarboxylic acid-functional monomer.

19. The aqueous polymer dispersion according to claim 15, wherein the monomer mixture contains stabilizing monomer other than the carboxylic acid-functional monomers, and wherein the amount of the one or more carboxylic acid-functional monomers exceeds an amount of all other stabilizing monomers by weight.

20. A coating composition comprising:
a) a pigment;
b) a filler;
c) the aqueous polymer dispersion according to claim 15.
